(19) United States
(12) Patent Application Publication
(10) Pub. No.: US 2024/0120610 A1
(43) Pub. Date: Apr. 11, 2024

(54) MODULE COVER FOR A BATTERY MODULE, BATTERY MODULE AND METHOD FOR PRODUCING A MODULE COVER

(71) Applicant: AUDI AG, Ingolstadt (DE)

(72) Inventors: Jürgen GERBRAND, Kirchberg an der Murr (DE); Julius RAUSCH, Heilbronn (DE); Jürgen STEGMAIER, Kirchberg (DE)

(73) Assignee: AUDI AG, Ingolstadt (DE)

(21) Appl. No.: 18/481,301

(22) Filed: Oct. 5, 2023

(30) Foreign Application Priority Data
Oct. 5, 2022 (DE) 102022125672.3

(51) Int. Cl. H01M 50/342; H01M 50/16; H01M 50/166

(52) U.S. Cl. CPC H01M 50/3425; H01M 50/16; H01M 50/166; H01M 2220/20

(57) ABSTRACT

A module cover for a battery module, which has a cell unit with at least one battery cell which includes a releasable vent opening. The module cover has a first region, which is associated with a vent opening region of the cell unit, in which the releasable vent opening of the at least one battery cell is arranged, and at least one second region different from the first region, which is associated with a cell region of the cell unit that is different from the vent opening region of the cell unit. The first region and the at least one second region of the module cover respectively include a plastic material. The at least one second region is formed with a continuous fiber reinforcement embedded in the plastic material and the first region is formed without a continuous fiber reinforcement.

### FIELD

The invention relates to a module cover for a battery module that has a cell unit with at least one battery cell that comprises a releasable vent opening. Furthermore, the module cover has a first region, which is associated with a vent opening region of the cell unit, in which the releasable vent opening of the at least one battery cell is arranged, wherein the module cover has at least one second region different from the first region, which is associated with a cell region different from the vent opening region of the cell unit, wherein the first region and the at least one second region of the module cover each comprise a plastic material. Furthermore, the invention also relates to a battery module having such a module cover and a method for producing a module cover.

### BACKGROUND

Battery modules often have a plurality of battery cells, which can be provided, for example, in the form of a cell stack. The battery cells can be clamped together, wherein the clamping can be provided by a module housing of such a battery module. Such a module housing can also have a module cover. Batteries for motor vehicles, in particular high-voltage batteries, can also comprise a plurality of such battery modules. These can be arranged in a common battery housing. In the context of the present invention, the focus is preferably on the cover of an individual battery module, that is to say not the cover of the entire battery housing, in which a plurality of such battery modules, each with a plurality of battery cells, are accommodated.

Battery cells also typically have releasable vent openings. In the event of a thermal runaway of such a battery cell, the gas or gas-particle mixture formed in the battery cell can exit in a controlled manner from such a releasable vent opening. This can, for example, be designed in the form of a predetermined breaking point in the cell housing. In order to be able to discharge such a gas in a controlled manner from the battery module and in particular from the entire high-voltage battery, the module covers can also be provided with corresponding openings.

For example, US 2021/0074974 A1 describes a battery module with a housing cover that has openings or holes at points located above the releasable vent openings of the cells. In this case, the cover is also made of a heat-resistant plastic material.

### SUMMARY

The object of the present invention is to provide a module cover, a battery module and a method which make it possible to further increase safety in the event of thermal runaway of a battery cell of a battery module.

A module cover according to the invention for a battery module, which has a cell unit with at least one battery cell, which comprises a releasable vent opening, has a first region which is associated with a vent opening region of the cell unit, in which the releasable vent opening of the at least one battery cell is arranged. In addition, the module cover comprises at least one second region which is different from the first region and which is associated with a cell region of the cell unit which is different from the vent opening region of the cell unit, wherein the first region and the at least one second region of the module cover each comprise a plastic material. The at least one second region is formed with a continuous fiber reinforcement embedded in the plastic material and the first region is formed without a continuous fiber reinforcement.

The invention is based on the knowledge that by embedding continuous fiber reinforcement in a plastic, the robustness and also the temperature resistance can be significantly increased. However, in the first region of the module cover, which is associated with the vent opening region of the cell unit, there should be the possibility that a gas emerging from the battery cell can penetrate this first region as easily as possible in order to be discharged from the battery module and in particular also from the energy storage comprising the battery module. However, a correspondingly more robust design of the module cover as a whole would mean that gases emerging from a battery cell could no longer be easily passed through. In addition, the invention is based on the knowledge that, in order to increase safety, it is very advantageous to keep the gases escaping from a battery cell away from the cell poles as far as possible. However, these are often arranged on the same side of a battery cell as the releasable vent opening. By providing a first region of the module cover, in which the cover is designed without continuous fiber reinforcement, and at the same time by providing at least a second region of the module cover, in which it is designed with an embedded continuous fiber reinforcement, it can now advantageously be achieved, that precisely these regions of the module cover, which are associated, for example, with cell poles and, for example, are arranged directly above such cell poles in relation to a certain direction, are made significantly more temperature-resistant and robust by the embedded continuous fiber reinforcement with respect to the first region, which is associated with the vent opening region of the cell unit. In the case of vent, this can therefore be penetrated particularly easily by the gases emerging from a cell, for example through melting, while the gases that then ultimately escape can be shielded all the more safely and reliably from the cell poles due to the continuous fiber reinforcement provided in at least one second region. If the gas were to come into contact with the cell poles, this could lead to additional short circuits, voltage breakdowns or the like and would further promote fire formation. This risk can now be additionally reduced by the described design of the module cover. The safety associated with energy storage for motor vehicles can therefore be increased. The embedding of a continuous fiber reinforcement to form the second region also allows a particularly weight-saving design option for the module cover, for example in contrast to the use of metallic materials or ceramic materials. This also makes the production of the module cover very easy.

The plastic material that is used for the first region and the at least one second region of the module cover can be the same plastic material or different plastic materials, which are then compatible at least with regard to the possibility of forming a cohesive connection, since this simplifies manufacturing. The plastic materials are preferably the same, since this has the advantage that the first and the at least one second region of the module cover can be connected particularly easily during production, in particular through a material connection of these plastic materials. The first region, for example except for the optional film mentioned later, can thus be provided, for example, simply by overmolding the at least one second continuous fiber region or by injecting it onto it. The plastic materials can be, for example, polypropylene or polyamide. Any other, especially thermoplastic, plastic material is also conceivable. By choosing the same plastic for the formation of the first region and the at least one second region, it can be automatically achieved that the polymeric matrix of the injection molding material, that is, the plastic material of the first region, is compatible or suitable for a cohesive bond or overmolding of the continuous fiber regions, that is to say the at least one second region.

There are various options for providing the second region with continuous fiber reinforcement. The second region can, for example, comprise one or more organic sheets, be provided as a layered structure made of UD (unidirectional) tapes or similar. The at least one second region is therefore preferably made up of a plurality of layers, wherein a respective layer can be provided with an endless fiber reinforcement.

Suitable continuous fibers comprise, for example, glass fibers and/or carbon fibers and/or Kevlar fibers. These are extremely temperature-resistant and non-flammable or flame-retardant. This allows the robustness of the at least one second region to be significantly increased compared to a conventional design made of plastic. It is also conceivable that the first region is designed as a non-fiber-reinforced plastic or fiber-reinforced plastic, but not with a continuous fiber reinforcement. Continuous fiber reinforcement is characterized by significantly longer fibers than in the case of a conventional fiber-reinforced plastic. In particular, the fibers can extend in the longitudinal direction of the fibers over the entire component, in this case over the entire at least one second region of the module cover formed with this continuous fiber reinforcement, wherein the direction of the fibers is irrelevant. The fiber directions of different layers, for example if the second region is constructed in multiple layers, can also differ from one another. The fiber direction of the fibers of the same layer can be the same or the fibers can be woven together in the form of a kind of fabric or similar and thereby cross each other or have different directions. In the case of UD tape, the fibers within such a tape layer all run in the same direction. If a plurality of such tape layers or band layers are arranged one above the other to form the at least one second region, the fibers of different layers can extend in the same directions or in different directions.

As explained in more detail later, the cell unit can be, for example, a cell stack with a plurality of battery cells arranged next to one another in a stacking direction. Theoretically, it is also conceivable that the cell unit is only provided by a single battery cell. The battery module is preferably used in an energy storage device for a motor vehicle, in particular a high-voltage battery. The battery cell can be, for example, a lithium-ion cell. The releasable vent opening can be designed as described above, for example in the form of a predetermined breaking point, for example as a bursting membrane, in a cell housing of the battery cell. This releasable vent opening can be designed in such a way that it is basically closed and is only released, for example by bursting at a certain overpressure within the battery cell.

The fact that the first region of the module cover is associated with a vent opening region of the cell unit and that the at least one second region of the module cover is associated with the cell region of the cell unit, which preferably represents a pole region of the cell unit in which at least one pole of the battery cell of the cell unit is arranged, should preferably be understood to mean that when the module cover is arranged as intended relative to the cell unit, the first region is arranged directly above the vent opening region of the cell unit with respect to a specific direction, which is later also defined as the third direction, and the at least one second region is arranged above the cell region, in particular a pole region, which is different from the cell vent region, and in which no releasable vent openings of battery cells comprised in the cell unit are arranged.

It is also particularly advantageous if the module cover is designed for a battery module with battery cells the cell poles of which are on the same side of this releasable vent opening. Particularly good protection can then be provided for the cell poles by the second regions of the module cover arranged above them. For example, such battery cells can be constructed in such a way that the releasable vent opening is located between the two cell poles of the battery cell on a first side of the battery cell. The cell region of the cell unit can then define a pole region, as already mentioned.

Therefore, it represents a further particularly advantageous embodiment of the invention when the module cover has two second regions, the first region extends in a first direction and is arranged between the two second regions with respect to a second direction perpendicular to the first, in particular wherein the first and second regions extend from a first end of the module cover with respect to the first direction to a second end of the module cover that is opposite with respect to the first direction. The first region as well as the two second regions can, for example, be essentially rectangular and extend over the entire length of the battery module cover in the first direction. This makes it possible to achieve in a simple and advantageous manner that the first region covers or overlays all of the releasable vent openings of the battery cells comprised in the battery module, while the two second regions of the module cover, cover the two cell pole regions on both sides of the vent opening region of the cell unit. In other words, the cell region of the cell unit that is different from the vent opening region of the cell unit can be a cell pole region in which one of the cell poles of the at least one battery cell is arranged, in particular one of the cell poles of a respective battery cell, in the case that the cell unit comprises a plurality of battery cells. In addition, as described, the cell unit can have two such cell regions on both sides of the vent opening region, and the module cover can have two corresponding second regions, which are arranged, for example, directly above these cell pole regions of the cell unit with respect to a third direction. Both second regions with the endless fiber reinforcement described above can therefore be designed to be particularly robust. This means that both cell pole regions of the cell unit can be reliably protected.

In a further advantageous embodiment of the invention, the module cover is completely closed in the first and at least one second region, that is, without openings or apertures that penetrate the module cover in the third direction. In the normal state, i.e. when no gas exits a battery cell, the module cover should not have any openings in the first or at least one second region. Such an opening can only form in the event of a gas escape from one of the cells, in particular by being formed or caused by the escaping gas itself. This completely closed design of the module cover, at least in the first region and preferably also in the two second regions, in the normal operating state is particularly advantageous, as this allows the sensitive, releasable vent openings of the battery cells to be significantly better protected. Instead, the module cover is preferably also designed with releasable opening locations, which, however, are only released in the event of venting from the underlying battery cell, in particular due to the gas pressure or the temperature of the gas emerging from the battery cell in question. Because the first region of the module cover, which corresponds to the cell vent region of the cell unit, is not designed with continuous fiber reinforcement, penetration of the module cover in this region by a gas emerging from a cell can be achieved particularly easily and reliably.

In a further very advantageous embodiment of the invention, the first region is divided into at least one first subregion, which corresponds to the cell vent opening of the at least one battery cell, and one second subregion, which surrounds the at least one first subregion with respect to the first and second directions. Furthermore, the first subregion is designed as a predetermined breaking point in the first region, in particular wherein the first subregion has a maximum thickness in a third direction perpendicular to the first and second directions, which is less than a minimum thickness of the second region of the module cover and in particular also less than a thickness of the second subregion with respect to the third direction. Due to the smaller wall thickness in the first subregion, which can correspond geometrically to the releasable vent opening of the battery cell, a predetermined breaking point can advantageously be provided. The first region can therefore advantageously be designed with a predetermined breaking point which corresponds to the releasable cell vent opening of the battery cell and which is implemented by the first subregion. This first subregion can therefore be adapted in terms of its geometry to the geometry of the releasable vent opening of the battery cell. This relates in particular to the dimensions of this releasable vent opening, i.e. its length and width in the first and second directions. If the cell unit comprises a plurality of battery cells, a plurality of first subregions corresponding to the number of battery cells can also be provided in the first region. The plurality of first subregions then form the first region together with the second subregion. In other words, the second subregion represents the remainder of the first region that is different from the first subregions.

In order to design this first subregion as a predetermined breaking point, it is particularly advantageous in the present case if this first subregion is designed with a smaller wall thickness than the second subregion surrounding this first subregion. In other words, the smaller wall thickness ensures that the first subregion can be easily breached by a gas emerging from a cell. The wall thickness, that is to say the thickness in the third direction, of the second subregion can correspond to the thickness of the second region or the two second regions, more precisely to a minimum thickness of the second regions. As explained in more detail later, additional structures, such as bulkheads and/or protruding latching elements, can be provided on one side of the module cover. The thickness of the second region in the region of these additional elements that protrude or rise with respect to the third direction can be correspondingly even larger.

According to a further very advantageous embodiment of the invention, the first subregion additionally has a local material weakening, for example in the form of a notch. This can extend within the first subregion along a line, in particular an open or closed line, or along a plurality of lines, which can be arranged in any way relative to one another, for example in a crossing, tangential or not crossing or not touching or branching manner, etc.

An additional local weakening of the material, for example in the form of a notch or incision or similar, makes it easier to break through in the event of vent. As a result, the wall thickness in the first subregion can be locally made even thinner, for example with a thickness of approximately 0.3 millimeters, than in the remaining first subregion, which can for example have a thickness of 0.5 millimeters. The material weakening can also be provided in the form of a perforation, which, however, does not completely penetrate the first subregion in the third direction. As described above, this is particularly advantageous for protecting the underlying cells and their releasable vent openings. The measures described can nevertheless easily ensure that a gas emerging from the cell can easily penetrate the module cover in the region of the first subregion by tearing it open in the region of the intended local material weakening.

The wall thickness, in particular the maximum wall thickness in the region of the first subregion, can be, for example, approximately 0.5 millimeters or generally be smaller than one millimeter, in particular smaller than 0.7 millimeters and preferably smaller than 0.6 millimeters. In the second subregion and in the second region, the minimum wall thickness can be greater than the wall thickness in the first subregion. The continuous fiber reinforcement or a respective second region is between 0.5 millimeters and 2.5 millimeters thick and, as described, lies above the contacts of the HV cells and protects them from direct contact with particles or a short circuit in the event of a thermal event. Preferably, the minimum wall thickness in the second region or regions is less than 1.5 millimeters and particularly preferably less than 1.2 millimeters.

In a further advantageous embodiment of the invention, the first subregion is provided by a part of a film which is arranged on a base element in which a through opening which corresponds to the first subregion and is completely covered by the film is arranged. The first region therefore does not have to be provided as an integral injection-molded component, as is possible or preferred in the previously described embodiments, but in this variant it can be composed of the base element, which is preferably provided as an integral injection-molded component, for example, and the film. In the base element, then, at the locations of the at least one first subregion or the a plurality of first subregions that correspond to the vent openings of the battery underlying cells, when the module cover is arranged as intended in relation to the cell unit, a through opening penetrating the base element completely in the third direction can be provided or a plurality of through openings can be provided, which are spaced apart from one another, and arranged for example in the first direction along a line, and which completely penetrate the base element in the third direction, which through openings are preferably covered on the outside by the film. A single film is preferably used to cover a plurality of these openings, as this simplifies production. Theoretically, it would also be conceivable to cover each opening with a separate film. The external arrangement of the film, which then accordingly provides a part of the later defined outer side of the module cover, has the advantage that it does not impair the internal formation of other structures, for example the bulkheads described below.

Providing the first subregions as part of such a film has the great advantage that a film can be made very thin, in particular significantly thinner than would be possible when forming the first subregions in an injection molding process. The film can have a thickness of, for example, 0.3 mm or less, in particular 0.2 mm or even 0.1 mm or less. The additional provision of a notch or something similar in the first subregion is then no longer necessary.

The film is preferably also made of a plastic and, as part of the first region, is also designed without continuous fiber reinforcement. In addition, the plastic from which the film is made or which the film comprises is preferably the same or at least compatible with the plastic of the base element in the first region in terms of a material connection. To connect the film to the base element or to fix the film to the base element, it is preferred to weld it to the base element. In principle, gluing or other fastening is also conceivable. The film is also arranged in an airtight manner on the base element, and in such a way that the module cover in the finished manufactured state or in the normal operating state as part of a battery module has no openings or apertures or holes, at least not in the first region.

In a further advantageous embodiment of the invention, the module cover has a first side that defines an inner side and a second side that defines an outer side. In an intended state of use of the module cover in the battery module, the inner side should face the cell unit and the outer side should face away from the cell unit. The module cover further has a bulkhead associated with the first subregion, which is arranged on the inner side of the module cover and protrudes from it with respect to the third direction and at least partially or completely surrounds the first subregion along its boundary to the second subregion. This bulkhead can provide a type of collar that runs completely or partially around the first subregion or a protruding rib that runs partially or completely around it, which serves to direct or guide a gas emerging from the underlying cell in the direction of the first subregion. This can reduce the risk of gas getting into a region between the module cover and the cell unit. This bulkhead can be designed in such a way that when the module cover is arranged as intended in relation to the cell unit, the bulkhead extends at least almost to the battery cell.

If the cell unit comprises a plurality of battery cells, the module cover also has a plurality of first subregions in the first region that correspond to the respective cell vent openings. The respective first subregions are accordingly spatially separated from one another. The remaining region of the first region, which is different from these first subregions, forms the second subregion. This therefore represents a contiguous second subregion surrounding all first subregions. If the module cover therefore has a plurality of first subregions, such a bulkhead is provided at least on one of the first subregions. However, a plurality of subregions, in particular all subregions, of the module cover can also be designed with such a partially or completely surrounding bulkhead, depending on the available installation space conditions. Thus, such a bulkhead can also be designed with interrupted regions along its extension around the assigned first subregion. The respective bulkheads associated with different first subregions can also be designed differently. For example, some can completely surround the associated first subregion, while others can only partially or intermittently surround it. In addition, some or all of these bulkheads can be designed with locking lugs, as explained in more detail below.

Accordingly, a further advantageous embodiment of the invention provides that the module cover has a clip connection mechanism on the inside for connecting the module cover to a battery module lower part of the battery module, in particular wherein the bulkhead has a lug facing away from the first subregion for providing part of the clip connection mechanism. The bulkhead can have a lug or a corresponding projection extending completely along it, or can only be partially or locally designed with such a lug. Even if the bulkhead only partially surrounds the first subregion, such a bulkhead can be designed with such a lug, which in turn can extend along the entire bulkhead or can only be partially or locally formed on the bulkhead. This lug can then be locked with a complementary locking element when the module cover is arranged on the cell unit. This advantageously allows the module cover to be arranged on the cell unit without having to screw or glue it, for example. Breakthroughs in the module cover can thus advantageously be avoided. At the same time, the design as a clip connection mechanism enables the module cover to be arranged on the cell unit in a non-destructively removable manner.

It is also conceivable that such a clip connection mechanism is formed by other latching elements, which are not provided by the bulkheads themselves, but by separate locking elements provided on the inside of the module cover. Such locking elements that are separate from the bulkhead can also be provided in addition to the lugs formed on the bulkhead. In addition, in the case of a plurality of first subregions and corresponding first bulkheads, not each of these bulkheads has to be designed with such a locking lug. Such locking lugs can also be provided on only one or only some of the bulkheads.

It is also advantageous if the corresponding lugs formed on the bulkheads face away from the first subregion. In the event of a gas discharge from a cell, the lugs then do not protrude into the gas stream flowing through the first subregion. In addition, the complementary latching elements can be arranged on the cell unit outside the vent path.

In a further advantageous embodiment of the invention, the module cover, preferably at the first and/or second end of the module cover, has an edge which protrudes at an angle other than zero relative to the first and second region, wherein the edge has at least one edge portion associated to the at least one second region, which has a first part formed integrally with the second region, which is also formed with a continuous fiber reinforcement, and a part facing away from the second region, which represents a plastic material edge that is molded onto the first part or partially injected around the first part. The edge, if it is arranged at the first and/or second end of the module cover, can extend continuously or with interruptions in the second direction over the entire width of the module cover or only over a part of the width in the second direction. The same applies to the edge in relation to the length of the module cover in the first direction if the edge is arranged at a third and/or fourth end of the module cover, wherein the third and fourth ends delimit the module cover in and against the second direction.

The provision of such a protruding edge is particularly advantageous at the first and/or second end of the module cover, since in the event of a thermal event, gas is often discharged above the module cover in a vent channel extending in the first direction. This means that the discharged gas is also guided over the first and/or second end of the module cover. Because the module cover is now designed with such a protruding edge at the first and/or second end, in particular an edge protruding towards the inside, the cell unit can be protected even more reliably against possible gas ingress, for example via the edge region of the module cover. The edge of the module cover is therefore bent in the direction of the cell unit when it is arranged as intended on the cell unit. The angle can be, for example, 90 degrees, but is preferably different from 90 degrees, for example different from 90 degrees by five to ten degrees. Furthermore, the edge can be understood as a continuation of the first or of the at least one second region of the module cover. The edge portion of the edge, which corresponds to the second region or directly adjoins it, can thus also be designed with an endless fiber reinforcement. More precisely, the continuous fiber reinforcement of the second region also continues uninterrupted in the adjacent edge portion. An edge portion, which, for example, immediately adjoins a first region of the module cover, is also designed without continuous fiber reinforcement.

As already mentioned, the edge does not have to extend continuously over the entire width of the module cover in or against the second direction, but can also only be partially provided with respect to the second direction or can be designed with openings. For example, cables or lines from the battery module can be routed to the outside through such openings.

Because the edge portion corresponding to the second region is molded with a plastic edge or has a molded plastic edge, a smooth edge can advantageously also be provided in the region of the continuous fiber reinforcement.

Alternatively or additionally, the module cover can also have such an angled protruding edge at the above-mentioned third and/or fourth end. This then also adjoins a respective second region and is accordingly preferably also designed with a continuous fiber reinforcement. Accordingly, these edges can also be designed with an injection-molded plastic edge.

The overmolded or molded plastic edge can in turn be made of the same plastic material as that used for the first and second regions, or with a material which is at least compatible with them, in order to form a material connection with them.

Furthermore, the invention also relates to a battery module with a module cover according to the invention or with one of its embodiments.

The advantages described for the module cover according to the invention and its embodiments thus apply similarly to the battery module according to the invention.

In a further advantageous embodiment of the invention, the battery module has the cell unit with the at least one battery cell, which comprises the releasable vent opening, wherein the cell unit has a vent opening region in which the releasable vent opening of the at least one battery cell is arranged, wherein the module cover is positioned relative to the cell unit so that the first region is arranged above the vent opening region with respect to the third direction, in particular wherein the cell unit is designed as a cell stack with a plurality of battery cells arranged next to one another in the first direction, each of which has a releasable cell vent opening, wherein the vent opening region comprises all of the releasable cell vent openings. The vent opening region is therefore to be understood as the region of a cell stack in which all releasable cell vent openings of all battery cells comprised in the cell stack are arranged. The vent opening region is a contiguous region that extends over all cell vent openings and, so to speak, connects them to one another. The vent opening region is therefore a substantially rectangular region that extends over the entire cell stack, in particular centrally with respect to the second direction. The first region of the module cover is therefore designed to correspond, that is to say geometrically correspond, to this vent opening region, and is preferably arranged directly above this vent opening region with respect to the third direction, wherein the first region can be at a distance from the vent opening region of the cell unit. The first region therefore also extends in the first direction over the entire cell stack and is rectangular, in particular with a width in the second direction that corresponds to the width of the vent opening region.

According to a further advantageous embodiment, the cell vent opening is arranged on a first side of the battery cell, wherein the battery cell has at least one cell pole arranged on the first side, wherein the at least one second region of the module cover is arranged above the cell pole with respect to the third direction, in particular wherein the cell unit has a first pole region, in which a first cell pole of each battery cell is arranged, wherein the at least one second region is arranged above the first pole region with respect to the third direction. In a corresponding manner, the cell unit can also have a second pole region in which the other second cell pole of each battery cell is arranged. The other second region of the module cover then corresponds to the second pole region and is arranged directly above it with respect to the third direction. The two second regions of the module cover can also be rectangular and extend over the entire length of the cell stack in the first direction.

This results in the advantages of optimal protection of the cell poles already described above in the event of a thermal event, in that the second regions, which are particularly robust using the continuous fiber reinforcement, provide a reliable barrier between the flowing gas and the underlying cell poles.

Furthermore, the invention also should comprise a battery, in particular a high-voltage battery having a battery module according to the invention or one of its embodiments. The battery can also have a plurality of battery modules according to the invention or a plurality of battery modules according to exemplary embodiments of the invention.

A motor vehicle having a battery according to the invention or one of its embodiments, as well as a motor vehicle having a battery module according to the invention or one of its embodiments should also be regarded as comprised in the invention.

The motor vehicle according to the invention is preferably designed as an automobile, in particular as a passenger car or truck, or as a passenger bus or motorcycle.

Furthermore, the invention also relates to a method for producing a module cover for a battery module that has a cell unit with at least one battery cell that comprises a releasable vent opening. A first region for the module cover and a second region for the module cover are respectively produced at least partially from a plastic material. Furthermore, when producing the at least one second region, this is formed with a continuous fiber reinforcement embedded in the plastic material and the first region is formed without a continuous fiber reinforcement.

The advantages described in relation to the module cover according to the invention and its embodiments apply in the same way to the method according to the invention.

In addition, it is preferred that first the at least one second region with the continuous fiber reinforcement is provided, preferably the two second regions, and then the first region is formed between the two second regions or on the at least one second region in the second direction in an injection molding process, in which also the first region is then ultimately simultaneously joined to the at least one second region.

The invention also comprises developments of the method according to the invention, which have the same features which have already been described in conjunction with the developments of the module cover and battery module according to the invention. For this reason, the corresponding developments of the method according to the invention are not described again here.

The invention also comprises the combinations of the features of the described embodiments. The invention also comprises implementations that respectively have a combination of the features of a plurality of the described embodiments, provided that the embodiments were not described as mutually exclusive.

### BRIEF DESCRIPTION OF THE FIGURES

Exemplary embodiments of the invention are described hereinafter. In particular:

FIG. 1 shows a schematic cross-sectional representation of a part of an energy storage device having a battery module according to an exemplary embodiment of the invention;

FIG. 2 shows a schematic representation in a plan view of a module cover for a battery module according to an exemplary embodiment of the invention;

FIG. 3 shows a schematic representation from below of the module cover for a battery module according to an exemplary embodiment of the invention;

FIG. 4 shows a schematic representation from below of the module cover according to an exemplary embodiment of the invention;

FIG. 5 shows a schematic cross-sectional representation of a part of the module cover according to one exemplary embodiment of the invention; and

FIG. 6 shows a schematic representation of an edge region of the module cover according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

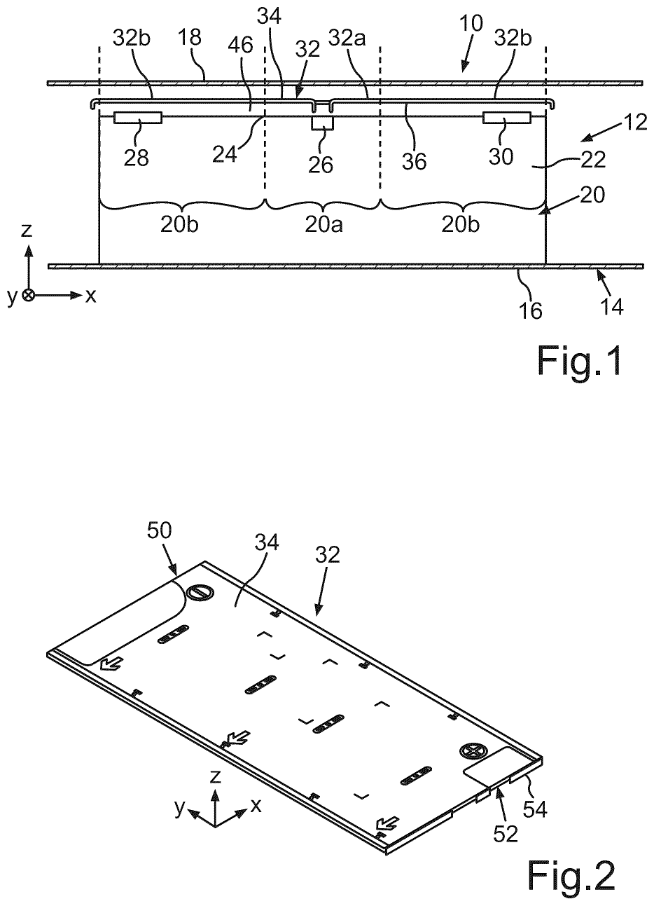

FIG. 1 shows a schematic representation of a part of an energy storage device 10 with a battery module 12 according to an exemplary embodiment of the invention. Of the energy storage device 10, which can be designed in particular as a high-voltage battery, in addition to the battery module 12, a part of a battery housing 14 with a housing base 16 and a housing cover 18 is shown. The energy storage device 10 can have not only one battery module 12, but also a plurality of battery modules 12, which can be arranged next to one another in the x direction, for example. The battery modules 12 can be constructed or designed in the same way.

The battery module 12 has a battery unit 20 which comprises at least one battery cell 22. In the present example, the battery unit 20 is designed as a cell stack 20 with a plurality of battery cells 22 arranged next to one another in the y-direction. A respective battery cell 22 has a releasable cell vent opening 26 on a first side 24, which can also be referred to as a vent opening 26 or simply as a vent 26. Furthermore, two cell poles 28, 30 of the battery cell 22 can be arranged on the first side 24, in particular on both sides with respect to the vent opening 26. One of the two cell poles 28, 30 of a cell is designed as a positive pole and the other as a negative pole. Furthermore, the battery module 12 comprises a module cover 32. This is arranged above the cell stack 20 with respect to the z-direction shown here. The cover 32 can be clipped onto the cell stack 20 using a clip mechanism that will be explained in more detail later. The cover 32 is preferably mechanically connected via clips or similar on the high-voltage module, that is to say the cell stack 20, in the battery box, that is to say the battery housing 14. The cover 18 of the battery box 14 is correspondingly arranged above the module cover 32 with respect to the z-direction, for example at a distance of preferably less than five millimeters.

In general, the cover 32 is made of an electrically insulating material, in particular plastic material. The cover 32 can be divided into three regions, in particular in the x direction, namely a first region 32a and two second regions 32b. These together form a substantially rectangular, flat plate with preferably locally different thicknesses and projections or elevations provided at least on the underside in the form of clips and/or bulkheads, which will be explained in more detail later. The first region 32a corresponds to a cell vent region 20a of the cell stack 20, in which the vent openings 26 of the battery cells 22 are arranged, and the two second regions 32b each correspond to a pole region 20b of the cell stack 20, in which the respective poles 28 and 30 of the battery cells 22 of the cell stack 20 are arranged. The first region 32a of the cover 32 is accordingly arranged between the two second regions 32b with respect to the X direction. Furthermore, the three regions 32a, 32b extend in the y direction over the entire cell stack 20. The component, namely the cover 32, is preferably implemented in an injection molding process with local continuous fiber reinforcement. Local here means that not the entire cover 32 has such an endless fiber reinforcement, but this is rather only implemented in the two second regions 32b, but not in the first region 32a. This makes it possible to provide a plastic HV (high-voltage) module cover 32, which takes on defined functions in the event of a thermal event, which functions are described in more detail in the following features. In principle, different wall thicknesses can also be implemented in these different regions 32a, 32b.

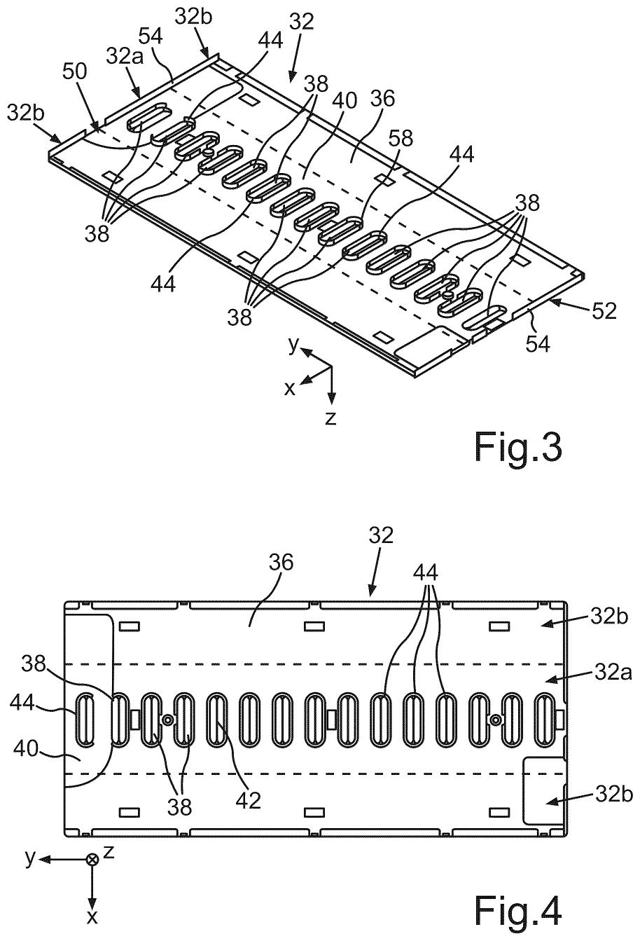

FIG. 2 shows again a schematic and perspective representation of the cover 32 in a plan view obliquely from above, that is to say on an outer side 34 of the cover, and FIG. 3 shows a schematic representation of the cover 32 obliquely from below, that is to say on an underside or inner side 36 of the cover 32, and FIG. 4 shows a schematic representation of a top view from centrally below the cover 32, that is again onto the underside or inner side 36 of the cover. The upper or outer side 34 of the cover 32 is essentially flat. The underside 36 or inner side 36, however, is not whole, as shown in FIG. 3 and FIG. 4. For better description, the first region 32a can be divided into first subregions 38 and a second subregion 40. The second subregion 40 surrounds the first subregions 38, which are designed essentially geometrically corresponding to the vent openings 26 of the cells 22. Each first subregion 38 is also arranged directly above such a vent opening 26 with respect to the z direction and also corresponds to the dimensions of the respective vent openings 26 of the respective cells 22 in terms of length and width in relation to the x and y directions. These regions, that is to say the first subregions 38, which sit directly above the vents 26 of the cells 22, preferably have a particularly small wall thickness, for example in the range of 0.5 millimeters or less, so that they melt through rapidly in the event of venting of cell 22. The distance between these first subregions 38 and the vents 26 of the cells 22 located directly below them in the z direction is less than 25 millimeters. Furthermore, the first region 32a, that is to say including all first subregions 38 and the second subregion 40, is composed of a continuous surface made of injection molded material, which protects the vents 26 or seals them upwards. In other words, this first region 32a as well as the second regions 32b of the cover 32 have no openings, apertures, holes or the like that completely penetrate the cover 32 in the z direction. As a result, the vents 26 are particularly well protected. Furthermore, the first subregions 38 in the region of the lines 42 shown or along the lines 42 shown can be designed with an additional material weakening in the form of a non penetrating perforation in the z direction, or rather in the form of a notch or incision, to facilitate breaking through in the event of the venting of a cell 22. The wall thickness in the region of this notch 42 along the drawn lines 42 can be even smaller than in the region of the remaining first subregions 38, for example only 0.3 millimeters.

Furthermore, it is very advantageous if a respective bulkhead 44 is arranged on the inner side 36 of the cover 32 on at least one of the first subregions 38 and preferably on a plurality of these subregions 38. These extend along the contour boundary between the associated first subregion 38 and the adjacent second subregion 40. In other words, these bulkheads 44 run along the boundary contour of the respective first subregions 38. Such a bulkhead 44 does not have to be arranged on each of the subregions 38. Some of the first subregions 38 are not surrounded by such a bulkhead 44 in the present case, for space-related reasons. Some of the bulkheads do not completely surround the assigned subregion 38, but only partially and also have local side openings, which can also have space-related reasons. These bulkheads 44 serve to improve gas guidance from the vent 26 of a cell 32 to the overlying first subregion 38 and prevent gas from getting into the intermediate region 46 (see FIG. 1) between the module cover 32 and the cell unit 20. In cross section, the first subregions 38 form the vent opening 26 with such an injection molding rib 44 providing the bulkheads 44 and thus direct the gas in a targeted manner to the desired position in the event of a thermal event, where the cover 32 should be burned through so that the gas can escape.

These bulkheads 44 can have a length relative to the z-direction of a few millimeters, for example between four and five millimeters, for example 4.3 millimeters. Due to component-related tolerances, it is preferred that these bulkheads 44 do not contact the underlying cells 22.

The regions of the cover 32, that is to say the second regions 32b of the cover 32, which lie above the contacts, that is to say the poles 28, 30 of the cells 22, have a wall thickness of preferably less than 1.5 millimeters, for example less than 1.2 millimeters, and are, as described, constructed as endless fiber-reinforced regions, for example from organic sheets and/or from a layered structure of UD tapes, or similar. The polymeric matrix of the injection molding material in the first region 32a is preferably compatible with or specific for a material bond or overmolding of the endless fiber regions 32b.

Furthermore, it is very advantageous, as shown schematically in FIG. 6, if the cover 32 has a downward step 54 on at least two sides, preferably in the region of a first end 50 and a second end 52 of cover 32 with respect to the y-direction, namely in the direction of the cell unit 20, which is made in parts from continuous fiber, wherein the edge is overmolded, so that the part is off-tool and does not have to be worked. The step 54 prevents particles from escaping unhindered to the outside in the event of a thermal event. FIG. 6 shows in particular a schematic cross-sectional representation of a part of the cover 32, for example in the region of the first end 50 of the cover 32. There the cover 32 has an edge 54, wherein presently an edge portion 54a of this edge 54 is shown, which directly adjoins one of the second regions 32b of the cover 32. In this edge portion 54a, the edge 54 is also formed with continuous fiber reinforcement and has an edge 56 overmolded with plastic. Furthermore, the edge 54 is preferably not perpendicular to the second region 32b of the cover 32, but is inclined outwards at an angle α in the range between five and ten degrees with respect to such a perpendicular S.

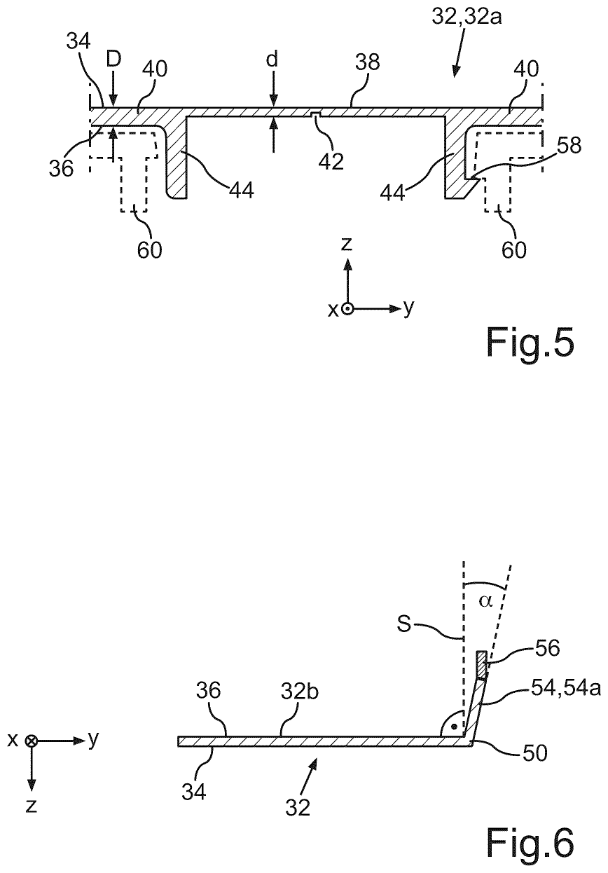

Furthermore, it is very advantageous if different regions of the cover 32 are designed with clips or latching lugs in at least one position for fastening the cover on the module, that is, on the cell unit 20. As shown in FIG. 5, such a latching lug 58 is exemplary designed as part of a bulkhead 44. In this case, the latching lug 58 points away from the first subregion 38 adjacent to the bulkhead 44. Incidentally, the notch 42 can also be seen in a cross-sectional view in FIG. 5. The thickness d of the first subregion 38 in the z-direction is smaller than a minimum thickness D in the second subregion 40. As shown here, the bulkhead 44 separates the first subregion 38 from the second subregion 40. The cell unit can be formed with a corresponding complementary latching structure 60, in which the latching lugs 58 of the cover 32 can snap into place.

As can also be seen in FIG. 3, a plurality of the bulkheads 44 can be designed with such latching lugs 58, but not every bulkhead 44 has to have such a latching lug 58. In addition, these latching lugs 58 can only be arranged on one side of a respective bulkhead 44, which is associated with a first subregion 38, with respect to the y direction, or can be arranged on both sides with respect to the first subregion 38.

Overall, the examples show how the invention can provide features of a high-voltage module cover and an arrangement in the battery box.

1. A module cover for a battery module which includes a cell unit with at least one battery cell, which comprises a releasable vent opening,
wherein the module cover has a first region, which is associated with a vent opening region of the cell unit, in which the releasable vent opening of the at least one battery cell is arranged,
wherein the module cover has at least one second region which is different from the first region and which is associated with a cell region of the cell unit which is different from the vent opening region of the cell unit;
wherein the first region and the at least one second region of the module cover each comprise a plastic material,
wherein the at least one second region is formed with a continuous fiber reinforcement embedded in the plastic material and the first region is formed without a continuous fiber reinforcement.

2. The module cover according to claim 1, wherein the module cover has two second regions, the first region extends in a first direction and is arranged between the two second regions with respect to a second direction perpendicular to the first, in particular wherein the first and second regions extend from a first end of the module cover with respect to the first direction up to a second end of the module cover that is opposite with respect to the first direction.

3. The module cover according to claim 1, wherein the module cover is completely closed in the first and at least one second region, that is, it is formed without openings or apertures that penetrate the module cover in a third direction.

4. The module cover according to claim 1,
wherein the first region is divided into at least one first subregion, which corresponds to the releasable cell vent opening of the at least one battery cell, and a second subregion, which corresponds to the at least one first subregion with respect to the first and second directions,
wherein the first subregion is designed as a predetermined breaking point in the first region,
wherein the first subregion has a thickness in a third direction perpendicular to the first and second directions which is less than a thickness of the second region of the module cover and in particular also less than a thickness of the second subregion with respect to the third direction,
wherein the first subregion additionally has a local material weakening, for example in the form of a notch, and/or wherein the first subregion is provided by a part of a film which is arranged on a base element, in which a through opening is arranged, which is completely covered by the film and corresponds to the first subregion.

5. The module cover according to claim 1, wherein the module cover has a first side which defines an inner side and a second side which defines an outer side, wherein the module cover has a bulkhead associated with the first subregion, which is arranged on the inner side of the module cover and protrudes from it with respect to the third direction and at least partially or completely surrounds the first subregion along its boundary to the second subregion.

6. The module cover according to claim 1, wherein the module cover has a clip connection mechanism on the inner side for connecting the module cover to a battery module lower part of the battery module, wherein the bulkhead has a lug facing away from the first subregion for providing a part of the clip connection mechanism.

7. The module cover according to claim 1, wherein the module cover, at the first and/or second end, has an edge which protrudes at an angle other than zero relative to the first and second region,
wherein the edge has at least one edge portion associated with the at least one second region, which portion has a first part formed integrally with the second region, which is also formed with a continuous fiber reinforcement, and a second part facing away from the second region, which represents a plastic material edge which is molded onto the first part or which is partially molded around the first part.

8. A battery module having a module cover according to claim 1, wherein the battery module comprises the cell unit with the at least one battery cell which comprises the releasable vent opening, wherein the cell unit has a vent opening region in which the releasable vent opening of the at least one battery cell is arranged, wherein the module cover is arranged relative to the cell unit in such a way that the first region is arranged above the vent opening region with respect to the third direction, wherein the cell unit is designed as a cell stack with multiple battery cells arranged next to one another in the first direction, each of which has a releasable vent opening, wherein the vent opening region comprises all of the releasable vent openings.

9. The battery module according to claim 8, wherein the releasable vent opening is arranged on a first side of the battery cell, wherein the battery cell has at least one cell pole arranged on the first side, wherein the at least one second region of the module cover is arranged above the cell pole with respect to the third direction, wherein the cell unit has a first pole region in which a first cell pole of each battery cell is arranged, wherein the at least one second region is arranged above the first pole region with respect to the third direction.

10. A method for producing a module cover for a battery module, which has a cell unit with at least one battery cell, which comprises a releasable vent opening, wherein one first and at least one second region for the module cover are each at least partially made of a plastic material,
wherein during the manufacturing of at least one second region, said region is formed with a continuous fiber reinforcement embedded in the plastic material and the first region is formed without a continuous fiber reinforcement.

11. The module cover according to claim 2, wherein the module cover is completely closed in the first and at least one second region, that is, it is formed without openings or apertures that penetrate the module cover in a third direction.

12. The module cover according to claim 2,
wherein the first region is divided into at least one first subregion, which corresponds to the releasable cell vent opening of the at least one battery cell, and a second subregion, which corresponds to the at least one first subregion with respect to the first and second directions,
wherein the first subregion is designed as a predetermined breaking point in the first region,
wherein the first subregion has a thickness in a third direction perpendicular to the first and second directions which is less than a thickness of the second region of the module cover and in particular also less than a thickness of the second subregion with respect to the third direction,
wherein the first subregion additionally has a local material weakening, for example in the form of a notch, and/or wherein the first subregion is provided by a part of a film which is arranged on a base element, in which a through opening is arranged, which is completely covered by the film and corresponds to the first subregion.

13. The module cover according to claim 3,
wherein the first region is divided into at least one first subregion, which corresponds to the releasable cell vent opening of the at least one battery cell, and a second subregion, which corresponds to the at least one first subregion with respect to the first and second directions,
wherein the first subregion is designed as a predetermined breaking point in the first region,
wherein the first subregion has a thickness in a third direction perpendicular to the first and second directions which is less than a thickness of the second region of the module cover and in particular also less than a thickness of the second subregion with respect to the third direction,
wherein the first subregion additionally has a local material weakening, for example in the form of a notch, and/or wherein the first subregion is provided by a part of a film which is arranged on a base element, in which a through opening is arranged, which is completely covered by the film and corresponds to the first subregion.

14. The module cover according to claim 2, wherein the module cover has a first side which defines an inner side and a second side which defines an outer side, wherein the module cover has a bulkhead associated with the first subregion, which is arranged on the inner side of the module cover and protrudes from it with respect to the third direction and at least partially or completely surrounds the first subregion along its boundary to the second subregion.

15. The module cover according to claim 3, wherein the module cover has a first side which defines an inner side and a second side which defines an outer side, wherein the module cover has a bulkhead associated with the first subregion, which is arranged on the inner side of the module cover and protrudes from it with respect to the third direction and at least partially or completely surrounds the first subregion along its boundary to the second subregion.

16. The module cover according to claim 4, wherein the module cover has a first side which defines an inner side and a second side which defines an outer side, wherein the module cover has a bulkhead associated with the first subregion, which is arranged on the inner side of the module cover and protrudes from it with respect to the third direction and at least partially or completely surrounds the first subregion along its boundary to the second subregion.

17. The module cover according to claim 2, wherein the module cover has a clip connection mechanism on the inner side for connecting the module cover to a battery module lower part of the battery module, wherein the bulkhead has a lug facing away from the first subregion for providing a part of the clip connection mechanism.

18. The module cover according to claim 3, wherein the module cover has a clip connection mechanism on the inner side for connecting the module cover to a battery module lower part of the battery module, wherein the bulkhead has a lug facing away from the first subregion for providing a part of the clip connection mechanism.

19. The module cover according to claim 4, wherein the module cover has a clip connection mechanism on the inner side for connecting the module cover to a battery module lower part of the battery module, wherein the bulkhead has a lug facing away from the first subregion for providing a part of the clip connection mechanism.

20. The module cover according to claim 5, wherein the module cover has a clip connection mechanism on the inner side for connecting the module cover to a battery module lower part of the battery module, wherein the bulkhead has a lug (58) facing away from the first subregion for providing a part of the clip connection mechanism.
